(19) United States
(12) Patent Application Publication
(10) Pub. No.: US 2025/0315602 A1
(43) Pub. Date: Oct. 9, 2025

(54) GENERATING FORMULAS IN DIGITAL ENVIRONMENTS

(71) Applicant: Notion Labs, Inc., San Francisco, CA (US)

(72) Inventors: Simon Townsend-Last, New York, NY (US); Paul Shen, San Francisco, CA (US); Chenyang Wu, San Francisco, CA (US); Yash Gaitonde, Ann Arbor, MI (US); Stephen Wu, San Francisco, CA (US)

(21) Appl. No.: 18/628,563

(22) Filed: Apr. 5, 2024

(51) Int. Cl. G06F 40/18; G06F 3/04847

(52) U.S. Cl. CPC G06F 40/18; G06F 3/04847

(57) ABSTRACT

A content platform displays a user interface for defining a formula to perform within a table, where the table includes a plurality of rows and a plurality of columns. An identifier of each of the plurality of columns is populated into the user interface for selection by a user. A selection is received, via the user interface, of a first identifier corresponding to a first column and an input to define an operation to be performed on a value in the first column. The formula is stored in association with a second column of the table, and can be executed to modify a value in the second column of the table based on performing the operation on the value in the first column.

### BACKGROUND

Spreadsheet applications often include formula functionality that enables users to define a formula for a cell in the spreadsheet. In these applications, a user can define a formula that automatically computes a value for one cell in the spreadsheet based on explicit inputs or based on value(s) for one or more other cells in the spreadsheet.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram illustrating a hierarchical organization of pages in a workspace.

FIG. 3 is a block diagram illustrating an environment in which formulas are generated.

FIG. 4A illustrates an example table that is displayed within a page of a content platform.

FIG. 4B illustrates an example user interface for creating a column within a table.

FIGS. 4C-4F illustrate example user interfaces to define a formula within a table.

FIG. 5 is a flowchart illustrating a process for creating a formula in a digital environment, according to some implementations.

FIG. 6 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides tools for defining formulas within an object in or associated with a digital environment. Existing spreadsheet technology enables users to define formulas in individual cells of a spreadsheet, but does not intelligently facilitate a process for creating formulas that takes into account the unique properties of the object in which a formula will operate.

According to implementations herein, a digital environment, such as a content platform, displays a user interface for defining a formula to perform within a table in the digital environment. The table can include a plurality of rows and a plurality of columns. An identifier of each of the plurality of column is populated into the user interface for selection by a user. A selection of a first identifier corresponding to a first column can be received via the user interface, as well as and an input to define an operation to be performed on a value in the first column. The formula is stored in association with a second column of the table, and can be executable to modify a value in the second column of the table based on performing the operation on the value in the first column.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

Some implementations of the disclosed technology include a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface-typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [“No”]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database-meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

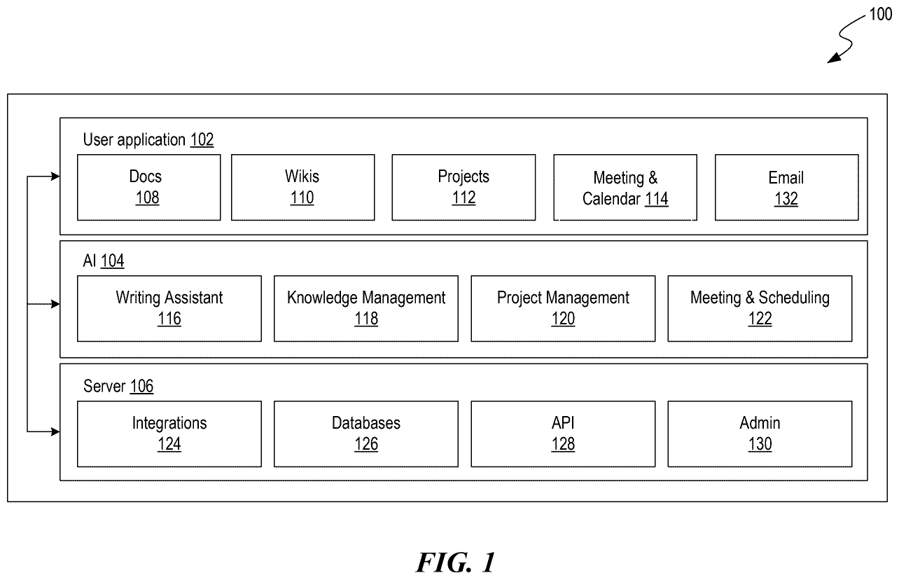

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, and a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The AI tool 104 is an integrated AI assistant that enables AI-based functions for the user application 102. In one example, the AI tool 104 is based on a neural network architecture. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Hierarchical Organizational Blocks in a Workspace

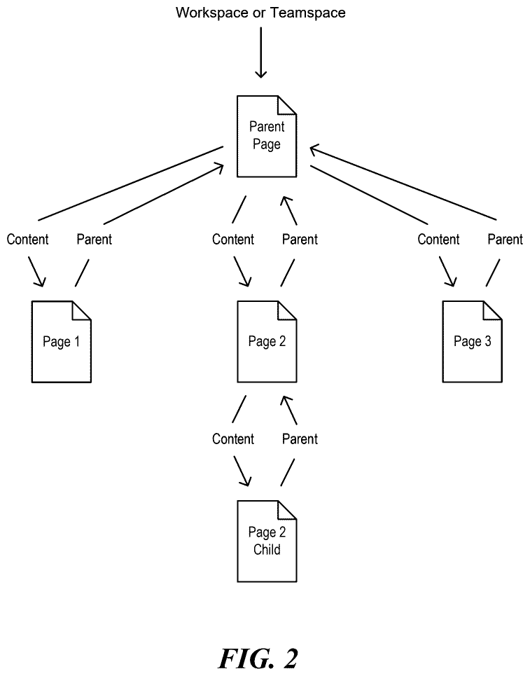

FIG. 2 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 2. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 2, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 2 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 2 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Automations in a Content Platform

A digital environment such as the data and project management platform 100 provides useful tools for users to store data, communicate, and collaborate. In such digital environments, formulas can enhance the usability and power of these environments by automatically performing calculations and other operations within objects. However, creating useful formulas within a digital environment can be challenging. According to implementations herein, a content platform facilitates a process for users to easily define and modify formulas within the platform.

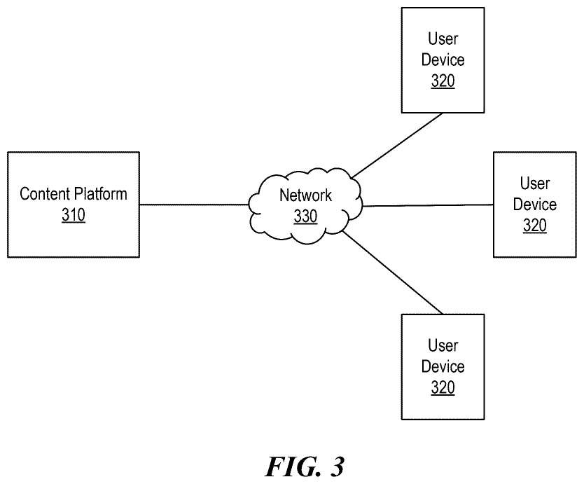

FIG. 3 is a block diagram illustrating an environment 300 in which formulas are generated. As shown in FIG. 3, the environment 300 can include a content platform 310 and user devices 320 communicating over a network 330, such as the Internet.

The content platform 310 is a digital environment that is accessible over the network 330. In some implementations, the content platform 310 can include aspects of the data and project management platform 100. Content from the platform 310 can be accessed via the user devices 320, such as via a browser application or native application executing on the devices 320.

The content platform 310 includes a variety of types of objects. Objects can include, for example, a page, a text block, a table or database, a calendar, a timeline, an image, a button, an embedded document, or blocks in a block data model as described above. Some objects include other objects or are themselves sub-objects of other objects on the platform. For example, a page can include one or more text blocks, tables, images, etc. Objects can also be linked to other objects. For example, a first page may contain a link to a second page.

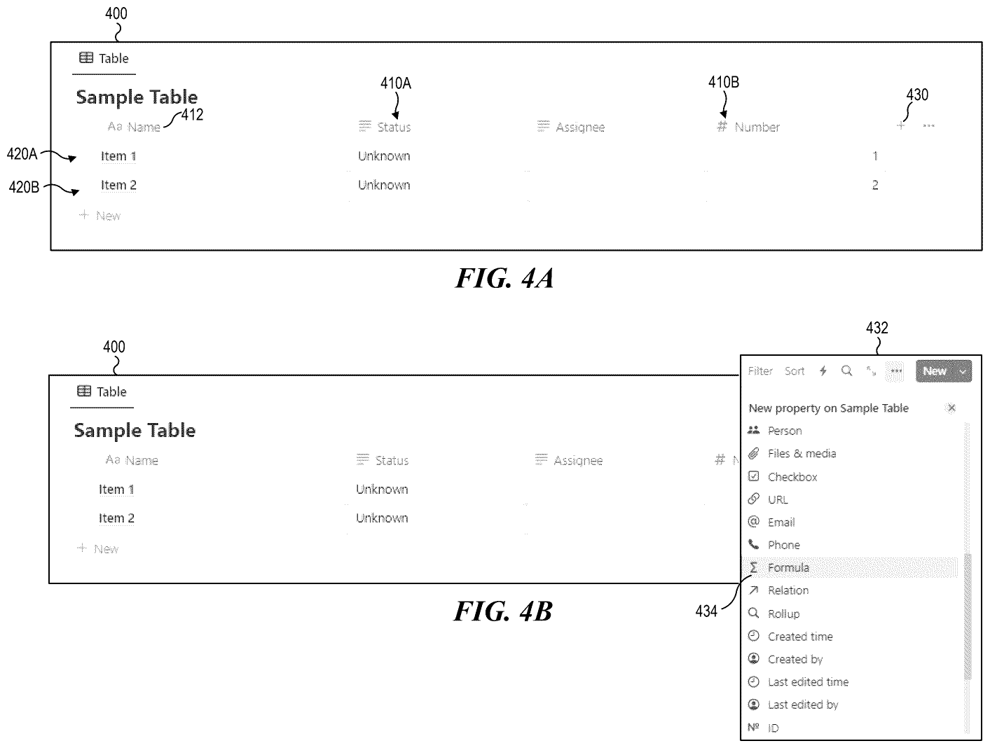

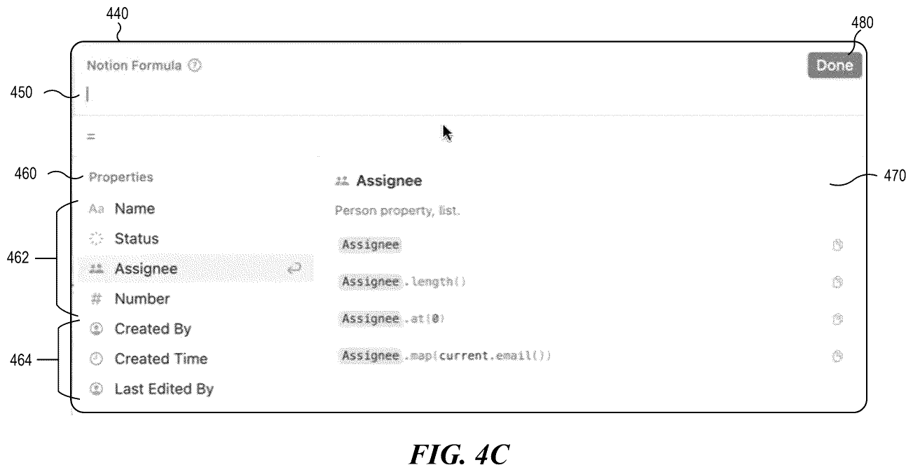

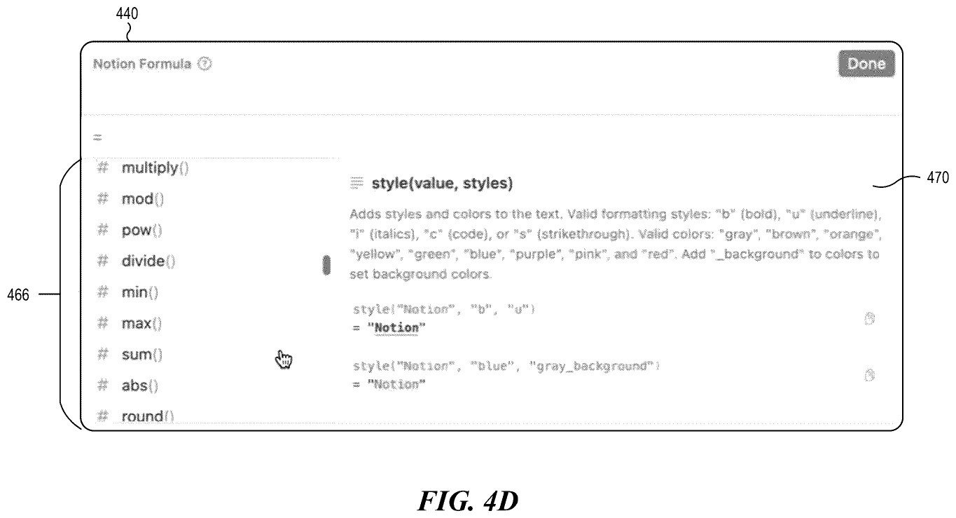

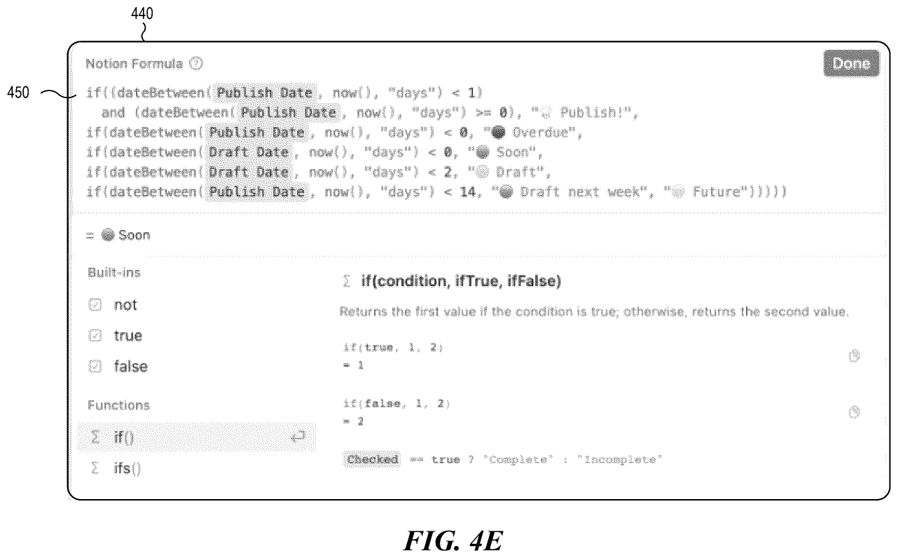

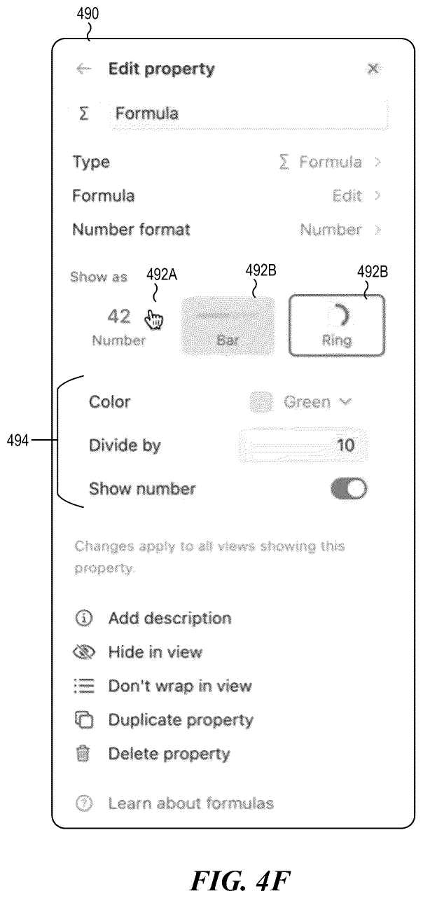

The content platform 310 enables users to define formulas that operate within objects of the platform. A formula generally performs one or more operations on one or more properties. By way of example, formulas are described herein as operating within tables, where a table can be either an independent object rendered on a page of the platform or a visual representation of a database. Within the example of a table, properties on which a formula operates can include identifiers of columns within a table, metadata attributes of the tables, or other values or variables as selected by a user. A process for creating a formula is illustrated in FIGS. 4A-4F.

The user devices 320 are computing devices used by users to access the content platform 310. The user devices 320 can display user interfaces that render content from the platform, as well as user interfaces that facilitate creation and modification of automations on the platform. In response to inputs received at these user interfaces, the user devices 320 can communicate instructions to the content platform 310.

Generating Formulas within a Digital Environment

An example process for creating a formula in an object of a digital environment is illustrated by user interfaces depicted in FIGS. 4A-4F. By way of example, the user interfaces can be generated by and displayed within the content platform 310. However, similar processes can be implemented in digital environments other than the content platform.

FIG. 4A illustrates an example table 400 that is displayed within a page of the content platform 310. The table 400 can be a visual representation of a database. The table includes a plurality of columns, such as columns 410A and 410B, and a plurality of rows, such as rows 420A and 420B. Each cell of the table, formed at the intersection of a column and a row, can contain a value that is input by a user or that is automatically inserted or modified by the content platform 310. For example, the content platform 310 can insert a value in a cell of the table 400 based on an event occurring in another cell of the table or in another object on the platform.

Each column of the table 400 can have a column identifier 412 that labels the column. The column identifier 412 can correspond to a property of the column, such as identifying a data type of data in the column. Users can also define their own column identifiers that may or may not explicitly define properties of the data within the column.

A user can select an option 430 to add a new column to the table 400. In some implementations, when the option 430 is selected, the content platform 310 displays a window 432, illustrated in FIG. 4B, that includes options for types of properties that can be added to the table. A user can select a property from among the displayed options or create a new property. The property selected or created by the user can be added to the table 400 as an identifier of the new column. Alternatively, a user can define a new column identifier that does not correspond to a particular property

The content platform 310 can automatically determine a data type of a value in each cell of the table 400. In some cases, the data type can be determined for each cell based on the value in the cell. For example, the platform can determine that an integer value in a cell has an integer data type, a number followed by a percentage symbol has a percentage data type, and a number preceded or followed by a currency symbol has a currency data type. In other cases, the content platform 310 determines data types based on the columns. At least some columns of the table can be identified by a property that has a certain associated data type. For example, the window 432 depicts example properties such as “Checkbox,” “Email,” and “Phone.” If a user adds a column with the “phone” property, for example, the content platform 310 determines that any numerical value entered into cells of the corresponding column have a telephone number data type. If a user adds a column with the “checkbox” property, the content platform 310 determines that the column holds Boolean data values.

FIG. 4B also illustrates an option 434 to create a formula column within the table 400. When a user selects the option 434 to create a formula, the content platform 310 outputs a user interface that enables a user to define a formula to be implemented in the new formula column.

FIG. 4C illustrates an example user interface 440 that is displayed within the digital environment and usable to define a formula within an object, such as the table 400. As shown in FIG. 4C, the user interface 440 can include a formula definition region 450, a list of selectable properties 460, and an informational region 470.

The formula definition region 450 includes a text box for a user to input components of a formula, including selecting any properties that will be operated upon as part of the formula, as well as defining the operation that will be performed. Users can create a formula by typing directly within the formula definition region 450 and/or by selecting properties and operations from the list of selectable properties 460.

The list of selectable properties 460 is a set of options for properties that a user can include in a formula. The list 460 can be populated by the content platform 310 based on the object for which the formula is being created. For example, the list 460 can include a set of identifiers 462 of each of the columns 410 in the table 400. When the user interface 440 is used to generate a formula associated with a table that has different columns than those present in the example table 400, the content platform 310 populates a different list of column identifiers into the user interface 440. The list 460 can also include a set of identifiers 464 of metadata attributes of the table that may or may not be explicitly displayed within columns of the table, such as the table's original author, a time of its creation, its last editor, or its last edit time. By providing identifiers of the table's columns in the list 460, the content platform 310 can improve user interfaces for creating formulas. For example, a user can readily select properties to be inputs for the formula from the list provided in the user interface 440, rather than either selecting an individual cell that may migrate to different relative positions within the table as rows or columns are added or removed, or navigating large menus with options that are not tailored to the particular object in which a formula is being created.

The informational region 470 can provide information about properties in the list 460. For example, the informational region 470 can identify a data type of each property as well as sample operations that can be performed on the property.

FIG. 4D illustrates that the user interface 440 can also display a list 466 of operations that can be applied to any properties selected by the user. When a user selects an operation from the list 466, the informational region 470 of the interface can provide information about the operation, such as a description of the actions it performs, its arguments, valid formats for the operation's arguments, or any other information that may help a user to correctly implement the operation.

As a user interacts with the user interface 440 to create or modify a formula, the content platform 310 can perform error checking to evaluate whether the formula is executable. For example, the content platform 310 can determine whether the formula includes the correct number of arguments of an operation, that a data type of a parameter used for an argument is the correct data type, or that syntax of the formula is correct. To perform error checking, the content platform 310 can perform typechecking of each property that is designated as an argument for each operation in the formula. If the data type of the property does not match the corresponding type needed for the argument, the content platform 310 can either force the property to the correct data type or output an error. Some implementations of the content platform 310 can also parse substrings of formulas to evaluate errors in formulas that are not well-formed. For example, if a data type of a property that is called in a formula changes after the formula is created, the formula may not be executable. The content platform 310 can parse one or more substrings of the formula, performing typechecking of the properties called within each substring, until the property with the now-incorrect data type is found. If any aspects of a formula are incorrect or nonexecutable, the content platform 310 can output an error to the user. For example, the content platform 310 can display an error in the informational region 470 of the interface. The content platform 310 can likewise modify a display format of components of the formula within the formula definition region 450, such as by displaying operations with incomplete argument sets in red, highlighting syntax errors, or the like.

Within the formula definition region 450, formulas and operations can be color-coded to visually aid a user while creating the formula. For example, a name of an operation can be displayed in one color while its arguments are displayed in another color. Alternatively, a name of an operation can be displayed in one color until the user has added the correct number and types of arguments to the operation, at which time the operation's name is displayed in a different color.

In some implementations, the formula definition region 450 supports multi-line display. FIG. 4E illustrates an example of the user interface 440 in which an example formula is being edited in the formula definition region 450. As shown, the example formula is distributed across six lines, logically separated such that each of six operations within the formula is displayed on its own line. Line breaks between the lines can be used only for display of the formula, with the content platform 310 ignoring any line breaks while parsing the formula. Thus, a user can use line breaks as helpful or needed to facilitate creation of the formula.

In some implementations, the content platform 310 enables a user to apply automatic formatting to the output of a formula. FIG. 4F is an example user interface 490 that can be displayed after the properties and operations of a formula have been defined on the user interface 440. For some types of formula outputs, the content platform 310 can offer type-specific formatting options, such as the options 492 illustrated in FIG. 4F. For example, if the data type of the formula output is expected to be a number, the content platform 310 enables a user to select whether to display the output as a number 492A, as a bar 492B, or as a ring 492C. Additional options 494 can be provided as well, depending on the data type of the output. For example, FIG. 4F illustrates that the user can select a text or background color for displaying the formula's output, choose whether to perform additional computations such as dividing the output by ten, or toggle an option to display a numerical value along with a ring or bar representation of the formula's output. If instead the formula outputs a currency data type, for example, the interface 490 can include options to display the output with a currency symbol or rounded to a specified value (e.g., an integer number of cents). If the formula outputs a percentage data type, the interface 490 can include options to display the output as a value between zero and one hundred, with a percentage sign following, or as a floating point value between zero and one without a percentage sign.

A user can interact with the user interface 440 to select or input one or more properties and to define at least one operation to perform on the properties. Once the formula is complete, the user can select a “Done” button 480 to finalize the formula and to cause it to be stored in association with a column of the table.

The formula can be applied across the plurality of rows of the table. For example, after a user has completed defining a formula, the content platform 310 can execute the formula to write a value to each row within the column with which the formula is associated. Similarly, if the user edits the formula, the value in each row can be updated automatically based on the edited formula. When the content platform 310 receives a change to a value in one row of a column that is called by the formula, the content platform 310 can execute the formula to update only the value in the cell of the same row of the formula column as the row in which the called value change was detected.

Some implementations of the content platform 310 enable formulas to reference properties outside the table 400. A user can interact with the user interface 440 to select properties from other objects within the platform, for example. The platform 310 also enables users to define sub-formulas that define a property, where an overall formula performs an operation on this defined property. For example, if a table of “projects” is related to a table of “tasks,” a user may be interested in adding a formula to the “projects” table that identifies whether a project is “complete,” “in progress,” or “not started,” based on a percentage of completed tasks associated with the project. Rather than creating an independent rollup property associated with the tasks table to show task completion, the user can create a sub-formula within a formula in the “projects” table. The sub-formula can first retrieve a number of completed tasks from the “tasks” table, using for example the following operations that call properties within the “tasks” table:
prop (“Tasks”).map (current.prop (“Status”)).filter (current== “Done”).length ( )

Then the user can define a custom property “percentComplete” that divides the number of completed tasks by the total number of tasks, and multiplies by 100:
let (percentComplete,
prop (“Tasks”).map (current.prop (“Status”)).filter (current== “Done”).length ( )/prop (“Tasks”).map (current.prop (“Status”)).length ( )*100),)

The formula within the “projects” table can then perform operations on the “percentComplete” property, such as displaying the completion percentage within a column of the “projects” table.

Although examples described herein relate to formulas within tables, implementations of the disclosed technologies can be used to create formulas within any type of block or object in a digital environment. User interfaces for creating formulas associated with other blocks or objects can be customized to the type of block or object with which the formula will be associated. For example, these user interfaces can provide options for properties to be called within the formula, where the options are populated based on properties of the associated block or object. Similarly, in some implementations, the user interfaces can provide recommended operations that are relevant to the types of data within the block or object or that are commonly used in association with the same type of block or object.

### Generating Formulas in Tables in a Digital Environment

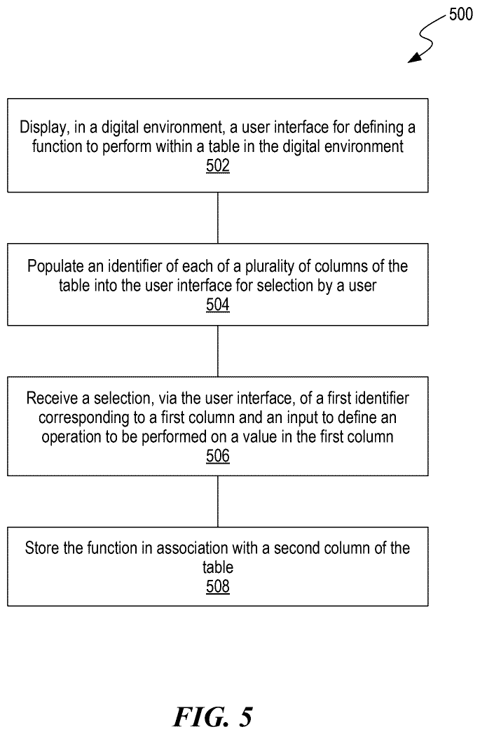

FIG. 5 is a flowchart illustrating a process 500 for creating a formula in a digital environment, according to some implementations. By way of example, the process 500 is described as being performed by a computing system associated with the content platform 310. However, the process 500 can be performed by any computing system and used to generate automations in any of a variety of types of digital environments. Other implementations of the process 500 can include additional, fewer, or different steps, or can perform the steps in different orders.

At 502, the computing system displays a user interface for defining a formula to perform within an object in the digital environment, such as a table. The table includes a plurality of rows and a plurality of columns, and each of the plurality of columns can include a name or label that identifies the column.

At 504, the computing system populates an identifier of each of the plurality of columns into the user interface for selection by a user. An identifier of one or more metadata attributes of the table can also be populated into the user interface, in some implementations.

At 506, the computing system receives a selection, via the user interface, of a first identifier corresponding to a first column. The computing system can also receive an input to define an operation to be performed on a value in the first column. A user may interact with the user interface to define multiple operations to perform on the value in the first column or to select multiple properties on which to perform one or more operations. Accordingly, the computing system can iterate step 506 until a user's selections are complete. The computing system can also perform error checking as the user inputs aspects of a formula, outputting an error if, for example, the user supplies an argument to an operation that has an incorrect data type.

At 508, the computing system stores the formula in association with a second column of the table. The formula can then be executed to modify a value in the second column of the table based on performing the operation on the value in the first column.

### Computer System

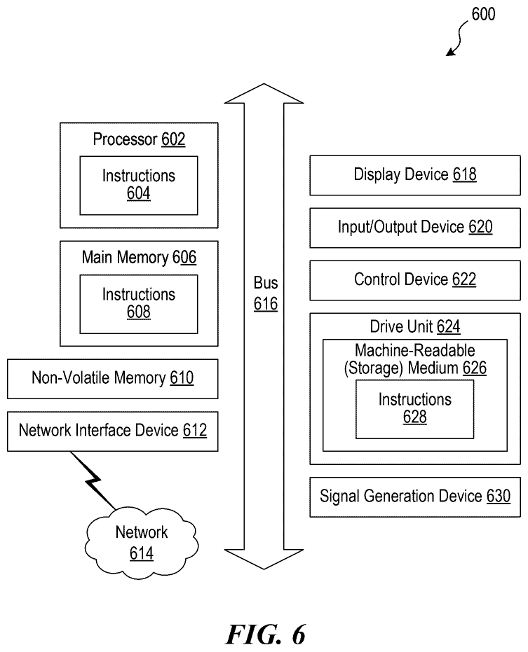

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a display device 618, an input/output device 620, a control device 622 (e.g., keyboard and pointing device), a drive unit 624 that includes a machine readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 600. In some implementations, the computer system 600 can be an embedded computer system, a system-on-chip (SOC), a single-board computer (SBC) system, or a distributed system such as a mesh of computer systems or include one or more cloud components in one or more networks. Where appropriate, one or more computer systems 600 can perform operations in real time, near real time, or in batch mode.

The network interface device 612 enables the computer system 600 to mediate data in a network 614 with an entity that is external to the computer system 600 through any communication protocol supported by the computer system 600 and the external entity. Examples of the network interface device 612 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computer system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A non-transitory, computer-readable storage medium comprising instructions recorded thereon, wherein the instructions, when executed by at least one data processor of a system, cause the system to:
display, in a digital environment, a user interface for defining a formula to perform within a table in the digital environment,
wherein the table includes a plurality of rows and a plurality of columns;
populate an identifier of each of the plurality of columns into the user interface for selection by a user;
receive a selection, via the user interface, of a first identifier corresponding to a first column and an input to define an operation to be performed on a value in the first column; and
store the formula in association with a second column of the table,
wherein the formula is executable to modify a value in the second column of the table based on performing the operation on the value in the first column.

2. The non-transitory computer-readable storage medium of claim 1, wherein the formula is executable to modify a value in each of the plurality of rows of the second column.

3. The non-transitory computer-readable storage medium of claim 2, wherein the instructions when executed further cause the system to:
receive an input, via the user interface, to create the formula; and
in response to the input, execute the formula to write the value in each of the plurality of rows of the second column.

4. The non-transitory computer-readable storage medium of claim 2, wherein the instructions when executed further cause the system to:
receive an input, via the user interface, to edit the formula; and
in response to the input, execute the formula to modify the value in each of the plurality of rows of the second column based on the edited formula.

5. The non-transitory computer-readable storage medium of claim 2, wherein the instructions when executed further cause the system to:
detect a change to a value in a first row of the first column; and
in response to detecting the change, execute the formula to modify a value in the first row of the second column based on the change.

6. The non-transitory computer-readable storage medium of claim 1, wherein displaying the user interface further comprises:
determining an expected output data type of an output of the formula;
displaying one or more formatting options for the output of the formula that are selected based on the expected output data type;
wherein the formula is executable to apply, to the value in the second column of the table, a selected formatting option from the one or more displayed formatting options.

7. The non-transitory computer-readable storage medium of claim 1, wherein displaying the user interface comprises:
providing, within the user interface, a formula definition region configured to display aspects of the formula while the formula is being defined;
wherein the formula definition region is configured to display the aspects of the formula on two or more lines, and
wherein line breaks between the two or more lines are ignored during execution of the formula.

8. The non-transitory computer-readable storage medium of claim 1, wherein the instructions when executed further cause the system to:
determine a data type of data in the first column;
determining a permissible data type of the operation; and
outputting an error when the data type of the data in the first column does not match the permissible data type of the operation.

9. The non-transitory computer-readable storage medium of claim 1, wherein displaying the user interface comprises populating the user interface with an identifier of one or more metadata attributes of the table for selection by the user.

10. A system comprising:
at least one hardware processor; and
at least one non-transitory memory storing instructions, which, when executed by the at least one hardware processor, cause the system to:
display, in a digital environment, a user interface for defining a formula to perform within a table in the digital environment,
wherein the table includes a plurality of rows and a plurality of columns;
populate, into the user interface for selection by a user:
an identifier of each of the plurality of columns; and
an identifier of one or more metadata attributes of the table;
receive a selection, via the user interface, of a first identifier corresponding to a first column and an input to define an operation to be performed on a value in the first column; and
store the formula in association with a second column of the table, wherein the formula is executable to modify a value in the second column of the table based on performing the operation on the value in the first column.

11. The system of claim 10, wherein the formula is executable to modify a value in each of the plurality of rows of the second column.

12. The system of claim 11, wherein the instructions when executed further cause the system to:
receive an input, via the user interface, to create the formula; and
in response to the input, execute the formula to write the value in each of the plurality of rows of the second column.

13. The system of claim 11, wherein the instructions when executed further cause the system to:
receive an input, via the user interface, to edit the formula; and
in response to the input, execute the formula to modify the value in each of the plurality of rows of the second column based on the edited formula.

14. The system of claim 11, wherein the instructions when executed further cause the system to:
detect a change to a value in a first row of the first column; and
in response to detecting the change, execute the formula to modify a value in the first row of the second column based on the change.

15. The system of claim 10, wherein displaying the user interface further comprises:
determining an expected output data type of an output of the formula;
displaying one or more formatting options for the output of the formula that are selected based on the expected output data type;
wherein the formula is executable to apply, to the value in the second column of the table, a selected formatting option from the one or more displayed formatting options.

16. The system of claim 10, wherein displaying the user interface comprises:
providing, within the user interface, a formula definition region configured to display aspects of the formula while the formula is being defined;
wherein the formula definition region is configured to display the aspects of the formula on two or more lines, and
wherein line breaks between the two or more lines are ignored during execution of the formula.

17. A method comprising:
displaying, in a digital environment, a user interface for defining a formula to perform within a table in the digital environment,
wherein the table includes a plurality of rows and a plurality of columns;
populating an identifier of each of the plurality of columns into the user interface for selection by a user;
receiving a selection, via the user interface, of a first identifier corresponding to a first column and an input to define an operation to be performed on a value in the first column; and
storing the formula in association with a second column of the table,
wherein the formula is executable to modify a value in the second column of the table based on performing the operation on the value in the first column.

18. The method of claim 17, further comprising:
executing the formula to modify a value in each of the plurality of rows of the second column.

19. The method of claim 18, further comprising:
receive an input, via the user interface, to create or edit the formula; and
in response to the input, execute the formula to write the value in each of the plurality of rows of the second column.

20. The method of claim 17, wherein displaying the user interface comprises:
providing, within the user interface, a formula definition region configured to display aspects of the formula while the formula is being defined;
wherein the formula definition region is configured to display the aspects of the formula on two or more lines, and
wherein line breaks between the two or more lines are ignored during execution of the formula.
